(19) United States
(12) Patent Application Publication
(10) Pub. No.: US 2015/0049133 A1
(43) Pub. Date: Feb. 19, 2015

(54) METHOD OF DISPLAYING A STEREOSCOPIC IMAGE, ORGANIC LIGHT EMITTING DISPLAY DEVICE, AND STEREOSCOPIC IMAGE DISPLAY SYSTEM

(71) Applicant: Samsung Display Co., Ltd., Yongin-city (KR)

(72) Inventors: Yang-Hwa CHOI, Yongin-si (KR); Ji-Gong Lee, Cheonan-si (KR)

(21) Appl. No.: 14/454,252

(22) Filed: Aug. 7, 2014

(30) Foreign Application Priority Data
Aug. 13, 2013 (KR) 10-2013-0096091

(51) Int. Cl. G09G 3/32; H04N 13/00; H04N 13/04

(52) U.S. Cl. CPC G09G 3/3275; H04N 13/0438; H04N 13/0051; G09G 2310/027; G09G 2320/0209
USPC 345/691; 345/76

(57) ABSTRACT

A method of displaying a stereoscopic image for an organic light emitting display device that selectively displays a planar image and the stereoscopic image using a digital driving technique. A display mode is set to be a stereoscopic image display mode, a left image frame is divided into a left black data period and a left real data period, a right image frame is divided into a right black data period and a right real data period, and the left image frame and the right image frame are synchronized with a left shutter and a right shutter of shutter glasses, respectively. The left real data period is set to be longer than the left black data period, and the right real data period is set to be longer than the right black data period.

### CROSS-REFERENCE TO RELATED APPLICATION

This application claims priority from and the benefit of Korean Patent Application No. 10-2013-0096091, filed on Aug. 13, 2013, which is hereby incorporated by reference for all purposes as if fully set forth herein.

### BACKGROUND

1. Field

Exemplary embodiments of the present invention relate to a stereoscopic (3D) image display technique. More particularly, exemplary embodiments of the present invention relate to a method of displaying a stereoscopic image for an organic light emitting display device that selectively displays a planar (2D) image and a stereoscopic image, an organic light emitting display device that employs the method of displaying the stereoscopic image, and a stereoscopic image display system having the organic light emitting display device.

2. Discussion of the Background

According to one stereoscopic image display technique, a stereoscopic image is displayed using a binocular parallax that provides a three-dimensional effect. Generally, a stereoscopic image display technique is classified into two types: a glasses-type stereoscopic image display technique, and a non-glasses-type stereoscopic image display technique. Recently, a shutter glasses-type stereoscopic image display technique has been widely used as the glasses-type stereoscopic image display technique. According to the shutter glasses-type stereoscopic image display technique, a stereoscopic image is displayed by dividing an image frame included in a stereoscopic image signal into a left image frame and a right image frame, and by alternately providing the left image frame and the right image frame to a left eye and a right eye through a left shutter and a right shutter of shutter glasses, respectively. Here, to prevent crosstalk between the left image frame and the right image frame, each of the left image frame and the right image frame includes a black data period for displaying an image corresponding to black data, and a real data period for displaying an image corresponding to real data.

Recently, an organic light emitting display device that selectively displays a planar image and a stereoscopic image has been suggested. In addition, a digital driving technique that displays one frame (i.e., one image frame) by displaying a plurality of sub-frames is widely employed in an organic light emitting display device. In the digital driving technique, one frame is divided into a plurality of sub-frames, respective emission time periods of the sub-frames are set to differ (e.g., by a factor of 2), and a specific gray level is displayed based on a sum of respective emission time periods of the sub-frames. However, conventional organic light emitting display devices employing the digital driving technique allocate all sub-frames included in one frame (e.g., 12 sub-frames may be included in one frame for an operation of 120 Hz) to the real data period when displaying the planar image. In addition, the conventional organic light emitting display devices employing the digital driving technique allocate half of the sub-frames included in one frame (e.g., 6 sub-frames for the operation of 120 Hz) to the real data period, and allocate the other half of the sub-frames included in one frame (e.g., 6 sub-frames for the operation of 120 Hz) to the black data period when displaying the stereoscopic image. As a result, the black data period is unnecessarily long (i.e., the real data period is insufficiently secured) in the conventional organic light emitting display devices, so that an image-quality of the stereoscopic image may be degraded.

The above information disclosed in this Background section is only for enhancement of understanding of the background of the invention and, therefore, it may contain information that does not constitute prior art.

### SUMMARY

Exemplary embodiments of the present invention provide a method of displaying a stereoscopic image for an organic light emitting display device, where the organic light emitting display device selectively displays a planar image and the stereoscopic image using a digital driving technique such that a real data period of a left image frame and a real data period of a right image frame are sufficiently secured when the stereoscopic image is displayed by the organic light emitting display device.

Exemplary embodiments of the present invention also provide an organic light emitting display device employing the method of displaying the stereoscopic image.

Exemplary embodiments of the present invention also provide a stereoscopic image display system having the organic light emitting display device.

Additional features of the invention will be set forth in the description which follows, and in part will become apparent from the description, or may be learned from practice of the invention.

An exemplary embodiment of the present invention discloses a method of displaying a stereoscopic image for an organic light emitting display device that selectively displays a planar image and the stereoscopic image using a digital driving technique. The method may include: setting a display mode of the organic light emitting display device to be a stereoscopic image display mode for displaying the stereoscopic image; dividing a left image frame into a left black data period, in which an image corresponding to black data is displayed, and a left real data period, in which an image corresponding to left real data is displayed; dividing a right image frame into a right black data period, in which an image corresponding to the black data is displayed, and a right real data period, in which an image corresponding to right real data is displayed; and synchronizing the left image frame and the right image frame with a left shutter and a right shutter of shutter glasses, respectively. The left real data period may be set to be longer than the left black data period, and the right real data period may be set to be longer than the right black data period.

Exemplary embodiments of the present invention also provide an organic light emitting display device including a display panel having a plurality of pixel circuits, a scan driving unit configured to provide a scan signal to the pixel circuits, a data driving unit configured to provide a data signal to the pixel circuits, a power unit configured to provide a high-power voltage and a low-power voltage to the pixel circuits, a timing control unit configured to control the scan driving unit, the data driving unit, and the power unit based on a digital driving technique, and a display mode control unit configured to control a display mode of the organic light emitting display device to selectively display a planar image and a stereoscopic image. The left image frame may be divided into a left black data period and a left real data period, and the right image frame may be divided into a right black data period and a right real data period when the stereoscopic image is displayed on the display panel. In addition, the left real data period may be set to be longer than the left black data period, and the right real data period may be set to be longer than the right black data period.

An exemplary embodiment of the present invention also discloses a stereoscopic image display system which may include: an organic light emitting display device configured to display a stereoscopic image using a digital driving technique that receives a stereoscopic image frame, divides the stereoscopic image into a left image frame and a right image frame, and alternately displays the left image frame and the right image frame based on a synchronization control signal; shutter glasses configured to alternately open a left shutter and a right shutter based on the synchronization control signal; and a stereoscopic image synchronization device configured to output the synchronization control signal to control the shutter glasses to open the left shutter when the organic light emitting display device displays the left image frame, and to output the synchronization control signal to control the shutter glasses to open the right shutter when the organic light emitting display device displays the right image frame. The organic light emitting display device may divide the left image frame into a left black data period and a left real data period, and may divide the right image frame into a right black data period and a right real data period. In addition, the organic light emitting display device may set the left real data period to be longer than the left black data period, and may set the right real data period to be longer than the right black data period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a flow chart illustrating an organic light emitting display device selectively displaying a planar image and a stereoscopic image using a digital driving technique.

FIG. 2 is a diagram illustrating image frames of a planar image displayed by an organic light emitting display device using a digital driving technique.

FIG. 3 is a diagram illustrating image frames of a stereoscopic image displayed by an organic light emitting display device using a digital driving technique.

FIG. 4 is a flow chart illustrating a method of displaying a stereoscopic image according to an exemplary embodiment.

FIG. 5A is a diagram illustrating an example in which a planar image is displayed using a random scan digital driving technique applied to the method of FIG. 4.

FIG. 5B is a diagram illustrating an example in which a stereoscopic image is displayed using a random scan digital driving technique applied to the method of FIG. 4.

FIG. 6 is a block diagram illustrating an organic light emitting display device according to an exemplary embodiment.

FIG. 7 is a concept diagram illustrating display modes of the organic light emitting display device of FIG. 6.

FIG. 8 is a block diagram illustrating a stereoscopic image display system according to an exemplary embodiment.

FIG. 9 is a concept diagram illustrating the stereoscopic image display system of FIG. 8.

FIG. 10 is a block diagram illustrating an electronic device having the stereoscopic image display system of FIG. 8.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of elements may be exaggerated for clarity. Like reference numerals in the drawings denote like elements.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or directly coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing exemplary embodiments only and is not intended to be limiting of the present inventive concept. As used herein, the singular forms “a,” “an” and “the” are intended to include the plural forms as well, unless the context clearly indicates otherwise. It will be understood that for the purposes of this disclosure, “at least one of X, Y, and Z” can be construed as X only, Y only, Z only, or any combination of two or more items X, Y, and Z (e.g., XYZ, XYY, YZ, ZZ). It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

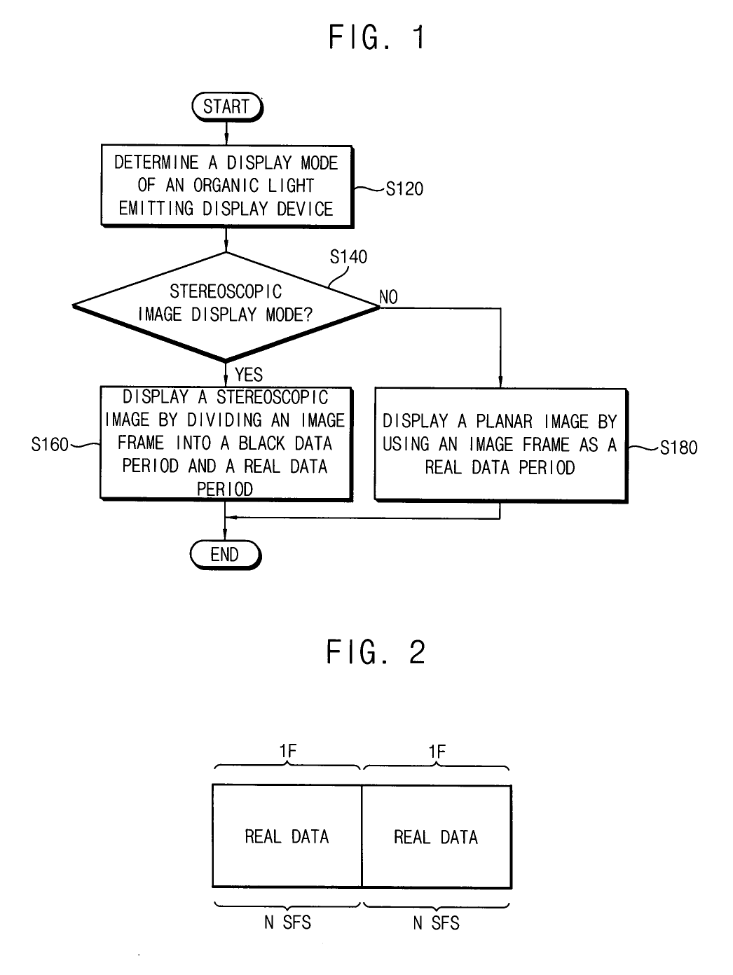

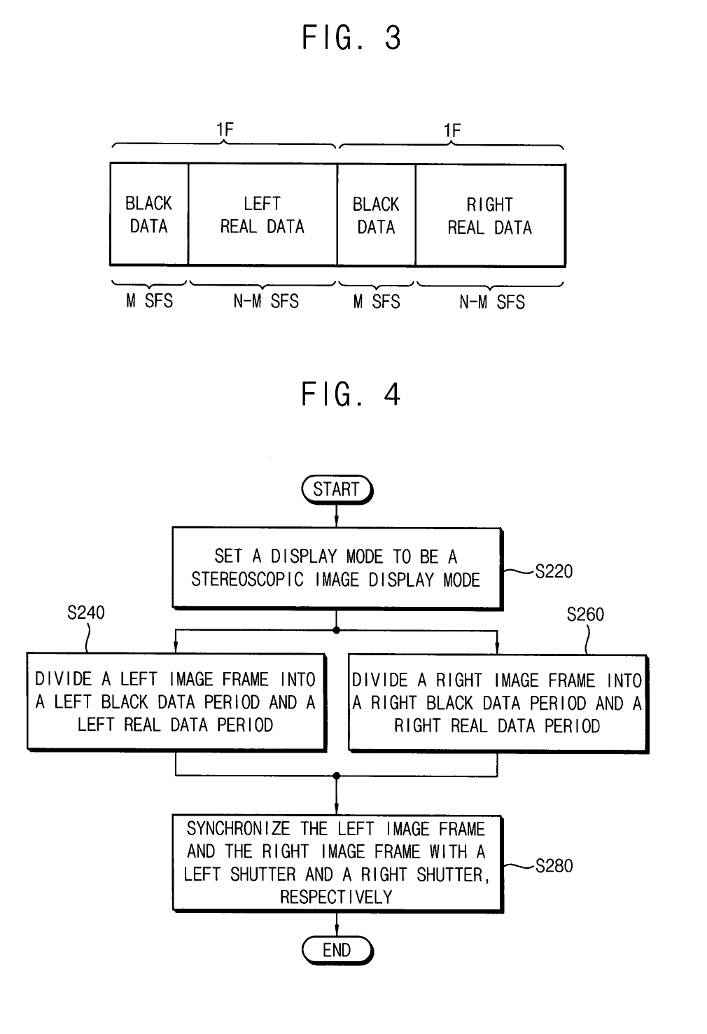

FIG. 1 is a flow chart illustrating an organic light emitting display device that selectively displays a planar image and a stereoscopic image using a digital driving technique. FIG. 2 is a diagram illustrating image frames of a planar image displayed by an organic light emitting display device using a digital driving technique. FIG. 3 is a diagram illustrating image frames of a stereoscopic image displayed by an organic light emitting display device using a digital driving technique.

Referring to FIGS. 1 through 3, the organic light emitting display device selectively displays a planar image and a stereoscopic image using the digital driving technique. Specifically, when a user determines a display mode of the organic light emitting display device (S120), the organic light emitting display device may decide whether the display mode is a stereoscopic image display mode (S140). If the display mode is the stereoscopic image display mode, the organic light emitting display device may display the stereoscopic image by dividing an image frame into a black data period and a real data period (S160). That is, a left image frame may be divided into a left black data period for displaying an image corresponding to black data and a left real data period for displaying an image corresponding to left real data, and a right image frame may be divided into a right black data period for displaying an image corresponding to black data and a right real data period for displaying an image corresponding to right real data. On the other hand, if the display mode is not the stereoscopic image display mode (i.e., the display mode is a planar image display mode), the organic light emitting display device may display the planar image by using an image frame as a real data period for displaying an image corresponding to real data (S180).

As illustrated in FIG. 2, the organic light emitting display device may display the planar image in the planar image display mode. In this case, the organic light emitting display device may use one image frame 1F as the real data period (i.e., indicated in FIG. 2 as “REAL DATA”) for displaying an image corresponding to the real data. In an exemplary embodiment, one image frame 1F may include N sub-frames SFS, where N is an integer greater than or equal to 2. That is, the organic light emitting display device employing the digital driving technique may divide one image frame 1F into a plurality of sub-frames SFS, may set respective emission time periods of the sub-frames SFS to differ from each other (e.g., by a factor of 2), and may display a specific gray level based on a sum of respective emission time periods of the sub-frames SFS. Each of the sub-frames SFS may correspond to each bit of a data signal. For example, the organic light emitting display device may allocate N sub-frames included in one image frame 1F to the real data period (i.e., indicated as “REAL DATA”) when displaying the planar image. For example, 12 sub-frames may be included in one image frame 1F for an operation of 120 Hz.

A stereoscopic image display technique may display a stereoscopic image by alternately providing a left image frame and a right image frame to a left eye and a right eye, respectively. For example, a shutter glasses-type stereoscopic image display technique may display a stereoscopic image by alternately displaying the left image frame and the right image frame by opening a left shutter of shutter glasses when the left image frame is displayed, and by opening a right shutter of the shutter glasses when the right image frame is displayed. Here, the left shutter of the shutter glasses may be open when the right shutter of the shutter glasses is closed, and the right shutter of the shutter glasses may be open when the left shutter of the shutter glasses is closed. A user (i.e., viewer) will not notice a timing difference between the operations because the operations are performed (i.e., repeated) very quickly. Thus, the viewer can recognize the stereoscopic image by sequentially watching the left image frame and the right image frame. In the stereoscopic image display mode, as illustrated in FIG. 3, the organic light emitting display device may display a stereoscopic image by alternately providing the left image frame and the right image frame to the left eye and the right eye, respectively, in synchronization with the operation of the shutter glasses (i.e., open-close operations of the left shutter and the right shutter).

To achieve this, the organic light emitting display device may divide one image frame 1F (i.e., the left image frame) into a left black data period (i.e., indicated as “BLACK DATA”) for displaying an image corresponding to black data, and a left real data period (i.e., indicated as “LEFT REAL DATA”) for displaying an image corresponding to left real data, and may divide one image frame 1F (i.e., the right image frame) into a right black data period (i.e., indicated as “BLACK DATA”) for displaying an image corresponding to black data and a right real data period (i.e., indicated as “RIGHT REAL DATA”) for displaying an image corresponding to right real data. For example, when one image frame 1F (i.e., the left image frame) includes N sub-frames SFS, the organic light emitting display device may allocate M sub-frames SFS to the left black data period (i.e., indicated as “BLACK DATA”), where M is an integer greater than or equal to 1, and may allocate N-M sub-frames SFS to the left real data period (i.e., indicated as “LEFT REAL DATA”). Similarly, when one image frame 1F (i.e., the right image frame) includes N sub-frames SFS, the organic light emitting display device may allocate M sub-frames SFS to the right black data period (i.e., indicated as “BLACK DATA”), and may allocate N-M sub-frames SFS to the right real data period (i.e., indicated as “RIGHT REAL DATA”). Thus, the left black data period and the right black data period may prevent a crosstalk between the left image frame and the right image frame.

Because conventional organic light emitting display devices divide one image frame 1F into a plurality of sub-frames SFS, each having identical horizontal time periods 1H, the conventional organic light emitting display devices allocate a half of the sub-frames SFS included in one image frame 1F to the black data period, and allocate the other half of the sub-frames SFS included in one image frame 1F to the real data period when displaying the stereoscopic image. That is, assuming that one image frame 1F (i.e., the left image frame and the right image frame) includes 12 sub-frames SFS, the conventional organic light emitting display devices allocate 6 sub-frames SFS to the left black data period, and 6 sub-frames SFS to the left real data period. Similarly, the conventional organic light emitting display devices allocate 6 sub-frames SFS to the right black data period, and 6 sub-frames SFS to the right real data period. However, because 6 sub-frames SFS of the left image frame 1F are allocated to the left black data period, and 6 sub-frames SFS of the right image frame 1F are allocated to the right black data period, the left black data period and the right black data period are unnecessarily long compared with operations (i.e., roles) of the left black data period and the right black data period (i.e., the left real data period and the right real data period are insufficiently secured). As a result, image-quality of the stereoscopic image displayed by the conventional organic light emitting display devices may be degraded because an image corresponding to the left real data is displayed in the left real data period that includes only 6 sub-frames SFS of the left image frame, and an image corresponding to the right real data is displayed in the right real data period that includes only 6 sub-frames SFS of the right image frame.

To solve these problems, the present invention may divide one image frame 1F into a plurality of sub-frames SFS, in which horizontal time periods 1H differ based on which one of the black data period and the real data period the sub-frames SFS included in one image frame 1F are allocated. In other words, when one image frame 1F is divided into the black data period and the real data period, the present exemplary embodiment may sufficiently secure the left real data period (i.e., indicated as “LEFT REAL DATA”) of the left image frame and the right real data period (i.e., indicated as “RIGHT REAL DATA”) of the right image frame, where an image corresponding to real data is displayed in the real data period, by setting the black data period (i.e., indicated as “BLACK DATA”) to have a minimum time period in which at least one scan operation is completed on all scan-lines of an organic light emitting display device. As a result, the organic light emitting display device may display a high-quality image because a quantity of the sub-frames SFS allocated to the left real data period (i.e., indicated as “LEFT REAL DATA”) and the right real data period (i.e., indicated as “RIGHT REAL DATA”) is increased.

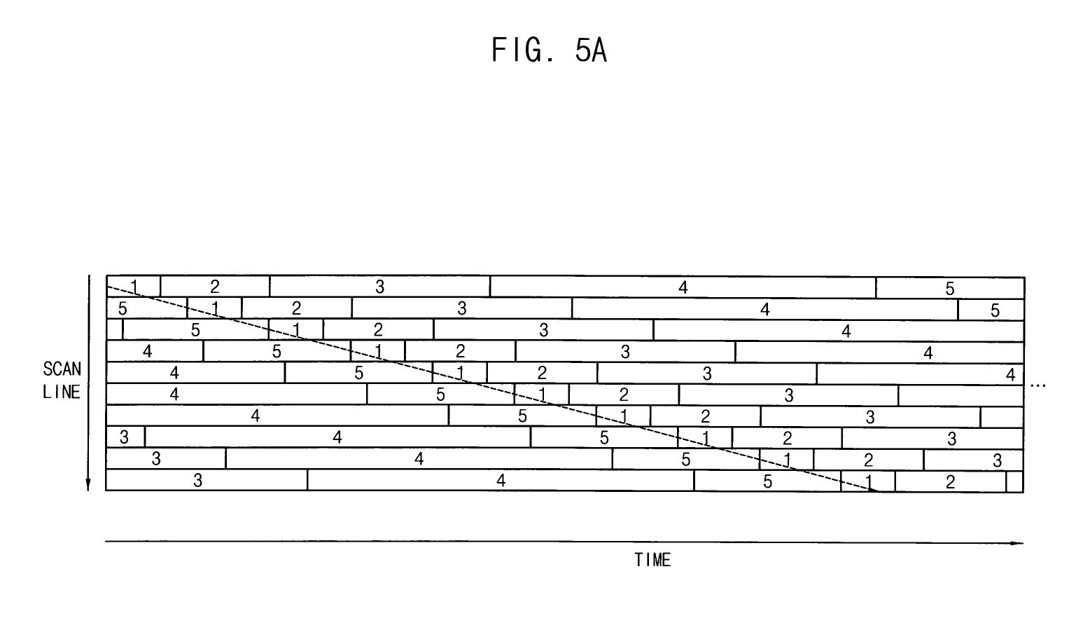

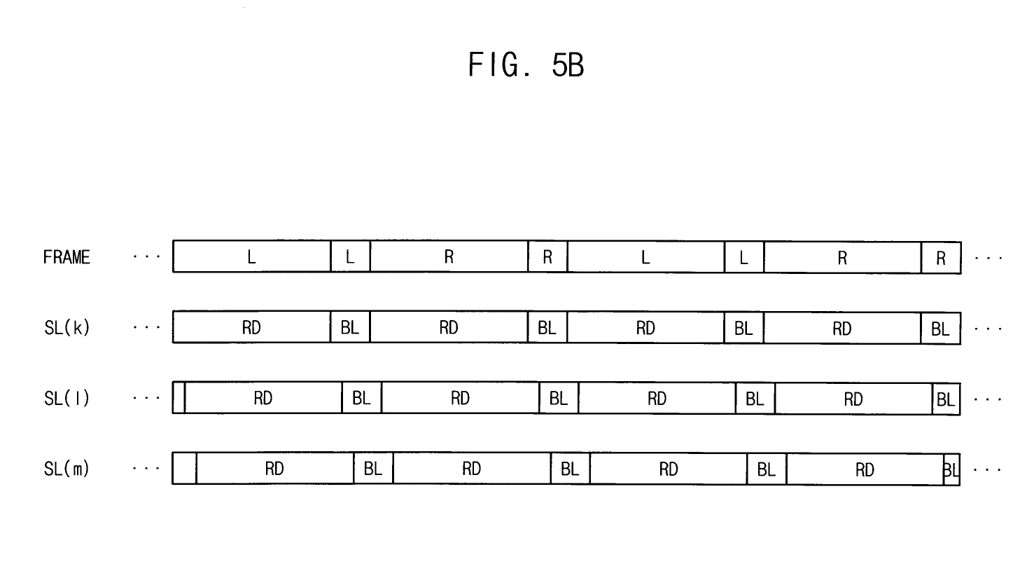

FIG. 4 is a flow chart illustrating a method of displaying a stereoscopic image according to an exemplary embodiment. FIG. 5A is a diagram illustrating an example in which a planar image is displayed using a random scan digital driving technique applied to the method of FIG. 4. FIG. 5B is a diagram illustrating an example in which a stereoscopic image is displayed using a random scan digital driving technique applied to the method of FIG. 4.

Referring to FIGS. 4 through 5B, the method of FIG. 4 may be employed in an organic light emitting display device that selectively displays a planar image and a stereoscopic image using a digital driving technique. Specifically, the method of FIG. 4 may set a display mode of the organic light emitting display device to be a stereoscopic image display mode for displaying the stereoscopic image (S220), divide a left image frame L into a left black data period BL in which an image corresponding to black data is displayed and a left real data period RD in which an image corresponding to left real data is displayed (S240), divide a right image frame R into a right black data period BL in which an image corresponding to black data is displayed and a right real data period RD in which an image corresponding to right real data is displayed (S260), and synchronize the left image frame L and the right image frame R with a left shutter and a right shutter of shutter glasses, respectively (S280). The method of FIG. 4 may set the left real data period RD to be longer than the left black data period BL for the left image frame L, and may set the right real data period RD to be longer than the right black data period BL for the right image frame R.

Specifically, the method of FIG. 4 may set the display mode of the organic light emitting display device to be a stereoscopic image display mode for displaying a stereoscopic image (S220). Thus, the organic light emitting display device may alternately display the left image frame L and the right image frame R using the digital driving technique. As described above, the organic light emitting display device employing the digital driving technique may divide one image frame into a plurality of sub-frames, may set respective emission time periods of the sub-frames to differ from each other (e.g., by a factor of 2), and may display a specific gray level based on a sum of respective emission time periods of the sub-frames.

Here, each of the sub-frames may correspond to each bit of a data signal. In an exemplary embodiment, the digital driving technique may correspond to a random scan digital driving technique. As illustrated in FIG. 5A, the random scan digital driving technique may display one image frame by displaying a plurality of sub-frames obtained by dividing the image frame. Here, the random scan digital driving technique may not sequentially perform a scan operation on all scan-lines of the organic light emitting display device. That is, the random scan digital driving technique may randomly perform a scan operation on all scan-lines of the organic light emitting display device. For convenience, FIG. 5A illustrates that the organic light emitting display device displays the planar image using the random scan digital driving technique. For example, one image frame may include one blank sub-frame 5 and four sub-frames 1, 2, 3, and 4. However, a quantity of sub-frames obtained by dividing one image frame is not limited thereto.

As illustrated in FIG. 5A, a sub-frame emission order may be fixed (e.g., 1->2->3->4->5). Here, the organic light emitting display device employing the random scan digital driving technique may randomly perform a scan operation on all scan-lines for each sub-frame 1, 2, 3, 4, and 5 by shifting each sub-frame scan timing of all scan-lines by a specific time, and, thus, may randomly (i.e., separately) perform an emission operation of all scan-lines for each sub-frame 1, 2, 3, and 4. Here, respective emission time periods of the sub-frames 1, 2, 3, and 4 may be set to differ from each other, and respective sub-frames 1, 2, 3, and 4 may correspond to respective bits of the data signal. For example, respective emission time periods of the sub-frames 1, 2, 3, and 4 (e.g., except for the blank sub-frame 5) may be increased by a factor of 2. Thus, when the organic light emitting display device, which employs the random scan digital driving technique, displays one image frame by displaying a plurality of sub-frames obtained by dividing the image frame, the organic light emitting display device, which employs the random scan digital driving technique, may randomly perform a scan operation on all scan-lines of the organic light emitting display device.

As illustrated in FIG. 5B, the organic light emitting display device, which employs the random scan digital driving technique, may alternately display the left image frame L and the right image frame R. For this operation, the organic light emitting display device employing the random scan digital driving technique may display one image frame (i.e., the left image frame L and the right image frame R) by displaying a plurality of sub-frames obtained by dividing the image frame (i.e., the left image frame L and the right image frame R). Here, one image frame (i.e., the left image frame L and the right image frame R) may be divided into the black data period BL and the real data period RD. Thus, the organic light emitting display device employing the random scan digital driving technique may randomly perform a scan operation on all scan-lines of the organic light emitting display device over time. For convenience of description, only scan-lines SL(k), SL(l), and SL(m) out of all scan-lines are illustrated in FIG. 5B.

The method of FIG. 4 may divide the left image frame L into the left black data period BL, in which an image corresponding to the black data is displayed, and the left real data period RD, in which an image corresponding to the left real data is displayed (S240), and may divide the right image frame R into the right black data period BL, in which an image corresponding to the black data is displayed, and the right real data period RD, in which an image corresponding to the right real data is displayed (S260). As illustrated in FIG. 5B, the method of FIG. 4 may allocate a plurality of sub-frames included in one image frame (i.e., the left image frame L and the right image frame R) into the black data period BL and the real data period RD, where one horizontal time period 1H of the sub-frames differs based on to which one of the black data period BL and the real data period RD the sub-frames are allocated. In other words, when the method of FIG. 4 divides one image frame (i.e., the left image frame L and the right image frame R) into the black data period BL and the real data period RD, the method of FIG. 4 may sufficiently secure the left real data period RD of the left image frame L and the right real data period RD of the right image frame R by setting the black data period BL to have a minimum time in which at least one scan operation is completed on all scan-lines of an organic light emitting display device.

In an exemplary embodiment, each of the left black data period BL and the right black data period BL may correspond to a time period in which one scan operation is completed on all scan-lines of the organic light emitting display device. In another exemplary embodiment, each of the left black data period BL and the right black data period BL may correspond to a time period in which a plurality of scan operations are completed on all scan-lines of the organic light emitting display device.

As described above, the method of FIG. 4 may enable the organic light emitting display device to display a high-quality stereoscopic image by decreasing a quantity of the sub-frames allocated to the left black data period BL and the right black data period BL, and by increasing a quantity of the sub-frames allocated to the left real data period RD and the right real data period RD. For convenience of description, the left black data period BL, the left real data period RD, the right black data period BL, and the right real data period RD are illustrated in FIG. 5B. Thus, the sub-frames allocated to each of the left black data period BL, the left real data period RD, the right black data period BL, and the right real data period RD are not illustrated in FIG. 5B. The method of FIG. 4 may set one horizontal time period 1H of the left black data period BL to be shorter than one horizontal time period 1H of the left real data period RD in connection with the left image frame L, and may set one horizontal time period 1H of the right black data period BL to be shorter than one horizontal time period 1H of the right real data period RD in connection with the right image frame R because the method of FIG. 4 decreases the left black data period BL and the right black data period BL, and increases the left real data period RD and the right real data period RD when dividing one image frame (i.e., the left image frame L and the right image frame R) into the black data period BL and the real data period RD.

The method of FIG. 4 may synchronize the left image frame L and the right image frame R with the left shutter and the right shutter of the shutter glasses, respectively (S280). Specifically, the method of FIG. 4 may control the left shutter of the shutter glasses to be open, and may control the right shutter of the shutter glasses to be closed when the organic light emitting display device displays the left image frame L. On the other hand, the method of FIG. 4 may control the right shutter of the shutter glasses to be open, and may control the left shutter of the shutter glasses to be closed when the organic light emitting display device displays the right image frame R. On this basis, the method of FIG. 4 may display the stereoscopic image by controlling the organic light emitting display device to alternately display the left image frame L and the right image frame R, and by controlling the operations of the shutter glasses (i.e., open-close operations of the left shutter and the right shutter). As a result, when the organic light emitting display device operates in the stereoscopic image display mode, the left image frame L and the right image frame R may be alternately provided to a left eye and a right eye of a viewer (i.e., a user) through the left shutter and the right shutter of the shutter glasses, respectively. In exemplary embodiments, the method of FIG. 4 may be implemented by hardware or software.

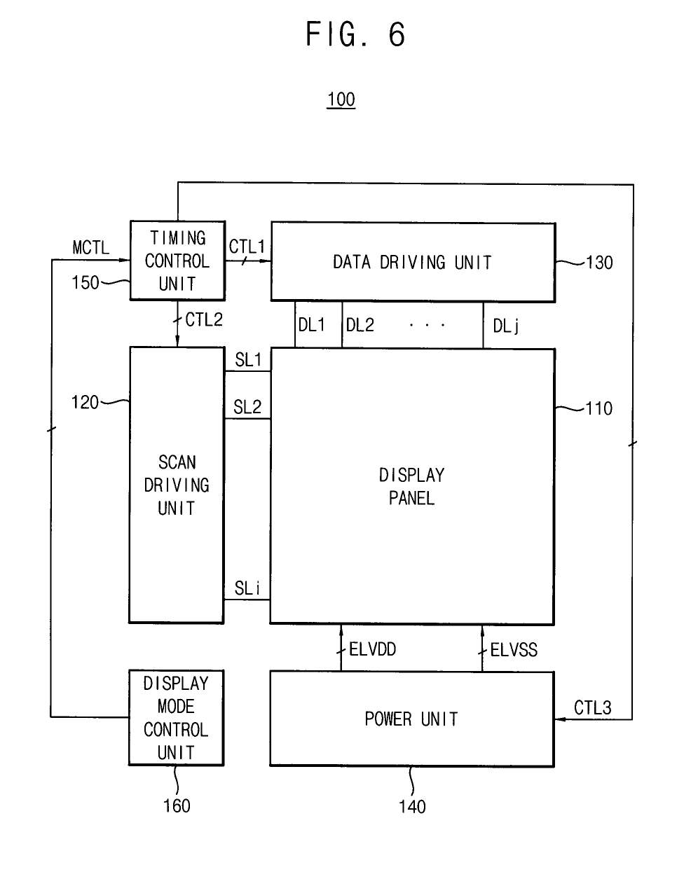

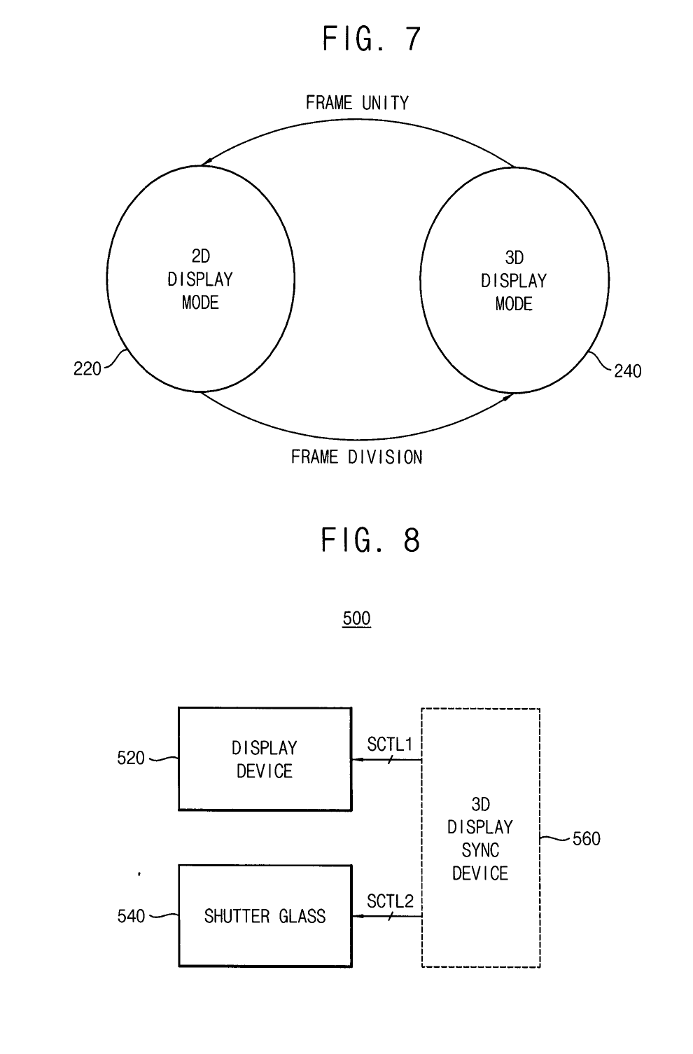

FIG. 6 is a block diagram illustrating an organic light emitting display device according to an exemplary embodiment. FIG. 7 is a concept diagram illustrating display modes of the organic light emitting display device of FIG. 6.

Referring to FIGS. 6 and 7, the organic light emitting display device 100 may include a display panel 110, a scan driving unit 120, a data driving unit 130, a power unit 140, a timing control unit 150, and a display mode control unit 160. As illustrated in FIG. 7, the organic light emitting display device 100 may selectively display a planar image and a stereoscopic image using a digital driving technique.

The display panel 110 may include a plurality of pixel circuits. The scan driving unit 120 may provide a scan signal to the pixel circuits via a plurality of scan-lines SL1 through SLi, where i is an integer greater than or equal to 1. The data driving unit 130 may provide a data signal to the pixel circuits via a plurality of data-lines DL1 through DLj, where j is an integer greater than or equal to 1. The power unit 140 may generate a high-power voltage ELVDD and a low-power voltage ELVSS, and may provide the high-power voltage ELVSS and the low-power voltage ELVSS to the pixel circuits via a plurality of power-lines. The timing control unit 150 may generate a plurality of control signals CTL1, CTL2, and CTL3, so that the organic light emitting display device may operate based on the digital driving technique. Thus, the timing control unit 150 may provide the control signals CTL1, CTL2, and CTL3 to the data driving unit 130, the scan driving unit 120, and the power unit 140, respectively, to control the data driving unit 130, the scan driving unit 120, and the power unit 140 based on the digital driving technique. In an exemplary embodiment, the digital driving technique may correspond to a random scan digital driving technique. The display mode control unit 160 may control a display mode of the organic light emitting display device 100. Thus, the planar image and the stereoscopic image may be selectively displayed on the display panel 110. For example, when a viewer (i.e., a user) sets the display mode of the organic light emitting display device 100 to be a planar image display mode 220, the display mode control unit 160 may provide a display mode control signal MCTL indicating the planar image display mode 220 to the timing control unit 150, so that the timing control unit 150 may control the data driving unit 130, the scan driving unit 120, and the power unit 140 to display the planar image on the display panel 110. On the other hand, when the viewer sets the display mode of the organic light emitting display device 100 to be a stereoscopic image display mode 240, the display mode control unit 160 may provide a display mode control signal MCTL indicating the stereoscopic image display mode 240 to the timing control unit 150, so that the timing control unit 150 may control the data driving unit 130, the scan driving unit 120, and the power unit 140 to display the stereoscopic image on the display panel 110.

As illustrated in FIG. 7, if the display mode of the organic light emitting display device 100 is the stereoscopic image display mode 240, the organic light emitting display device 100 may divide one image frame into a black data period and a real data period (i.e., indicated as “FRAME DIVISION”). That is, a left image frame may be divided into a left black data period and a left real data period, and a right image frame may be divided into a right black data period and a right real data period. On the other hand, if the display mode of the organic light emitting display device 100 is the planar image display mode 220, the organic light emitting display device 100 may use one image frame as a real data period (i.e., indicated as “FRAME UNITY”). In an exemplary embodiment, if the display mode of the organic light emitting display device 100 is the stereoscopic image display mode 240, the display mode control unit 160 may control the organic light emitting display device 100 to divide the left image frame into the left black data period and the left real data period, and to divide the right image frame into the right black data period and the right real data period. The display mode control unit 160 may control the organic light emitting display device 100 to set the left real data period to be longer than the left black data period, and to set one horizontal time period 1H of the left black data period to be shorter than one horizontal time period 1H of the left real data period. In addition, the display mode control unit 160 may control the organic light emitting display device to set the right real data period to be longer than the right black data period, and to set one horizontal time period 1H of the right black data period to be shorter than one horizontal time period 1H of the right real data period.

As described above, the organic light emitting display device 100 may reduce a quantity of sub-frames allocated to the left black data period and the right black data period, and may increase a quantity of sub-frames allocated to the left real data period and the right real data period. That is, the organic light emitting display device 100 may set the left real data period to be longer than the left black data period, and may set the right real data period to be longer than the right black data period. Thus, the organic light emitting display device 100 may sufficiently secure the left real data period of the left image frame and the right real data period of the right image frame, and thereby display a high-quality stereoscopic image.

In an exemplary embodiment, each of the left black data period and the right black data period may correspond to a time period in which one scan operation is completed on all scan-lines SL1 through SLi of the organic light emitting display device 100. In another exemplary embodiment, each of the left black data period and the right black data period may correspond to a time period in which a plurality of scan operations are completed on all scan-lines SL1 through SLi of the organic light emitting display device 100. As described above, according to a shutter glasses-type stereoscopic image display technique, the stereoscopic image may be displayed by alternately providing the left image frame and the right image frame to a left eye and a right eye of a viewer (i.e., a user) through a left shutter and a right shutter of shutter glasses, respectively. Therefore, the left shutter of the shutter glasses may be open, and the right shutter of the shutter glasses may be closed when the organic light emitting display device 100 displays the left image frame on the display panel 110. In addition, the right shutter of the shutter glasses may be open, and the left shutter of the shutter glasses may be closed when the organic light emitting display device 100 displays the right image frame on the display panel 110. For this operation, the organic light emitting display device 100 may be synchronized with the shutter glasses.

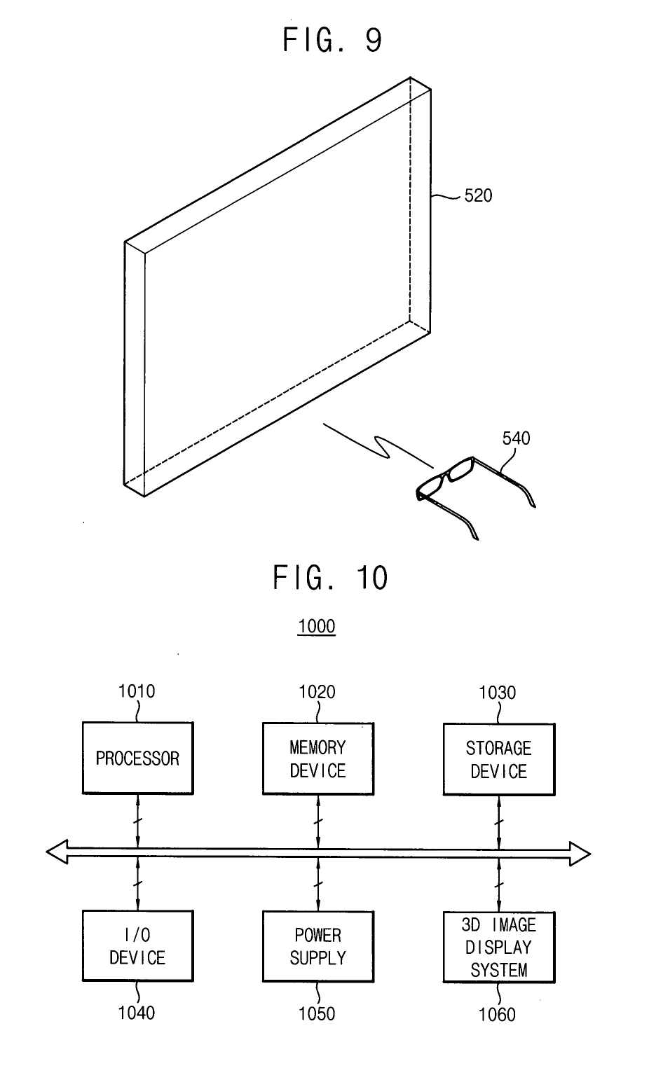

FIG. 8 is a block diagram illustrating a stereoscopic image display system according to an exemplary embodiment. FIG. 9 is a concept diagram illustrating the stereoscopic image display system of FIG. 8.

Referring to FIGS. 8 and 9, the stereoscopic image display system 500 may include an organic light emitting display device 520, shutter glasses 540, and a stereoscopic display synchronization device 560. Although FIG. 8 illustrates stereoscopic image synchronization device 560 are located outside the organic light emitting display device 520 and the shutter glasses 540, the present invention is not limited thereto. For example, the stereoscopic display synchronization device 560 may be located within the organic light emitting display device 520 or the shutter glasses 540.

The organic light emitting display device 520 may display a stereoscopic image using a digital driving technique (e.g., a random scan digital driving technique) by receiving a stereoscopic image frame, dividing the stereoscopic image frame into a left image frame and a right image frame, and by alternately displaying the left image frame and the right image frame based on first and second synchronization control signals SCTL1 and SCTL2 output from the stereoscopic display synchronization device 560. Here, the first synchronization control signal SCTL1 may be the same as the second synchronization control signal SCTL2. In an exemplary embodiment, a stereoscopic image signal corresponding to the stereoscopic image frame may be input based on a high definition multimedia interface (HDMI). When the organic light emitting display device 520 divides the left image frame into a left black data period and a left real data period, and divides the right image frame into a right black data period and a right real data period, the organic light emitting display device 520 may set the left real data period to be longer than the left black data period, and may set the right real data period to be longer than the right black data period. Thus, the organic light emitting display device 520 may set one horizontal time period 1H of the left black data period to be shorter than one horizontal time period 1H of the left real data period in connection with the left image frame, and may set one horizontal time period 1H of the right black data period to be shorter than one horizontal time period 1H of the right real data period in connection with the right image frame.

As described above, the organic light emitting display device 520 may sufficiently secure the left real data period of the left image frame and the right real data period of the right image frame, where an image corresponding to real data is displayed in the left real data period and the right real data period, by setting the left black data period and the right black data period to have a minimum time period in which at least one scan operation is completed on all scan-lines of the organic light emitting display device 520. In an exemplary embodiment, the organic light emitting display device 520 may include a display panel having a plurality of pixel circuits, a scan driving unit for providing a scan signal to the pixel circuits, a data driving unit for providing a data signal to the pixel circuits, a power unit for providing a high-power voltage and a low-power voltage to the pixel circuits, a timing control unit for controlling the scan driving unit, the data driving unit, and the power unit, where the timing control unit controls the organic light emitting display device 520 to operate based on a digital driving technique, and a display mode control unit for controlling a display mode of the organic light emitting display device 520. Because these are described above in FIG. 6, duplicate descriptions will not be repeated.

The shutter glasses 540 may open/close a left shutter and a right shutter in synchronization with the left image frame and the right image frame, respectively based on the second synchronization control signal SCTL2 when the organic light emitting display device 520 alternately displays the left image frame and the right image frame based on the first synchronization control signal SCTL1. Specifically, the shutter glasses 540 may open the left shutter (i.e., close the right shutter) when the organic light emitting display device 520 displays the left image frame, and may open the right shutter (i.e., close the left shutter) when the organic light emitting display device 520 displays the right image frame. For this operation, the stereoscopic display synchronization device 560 may provide the first and second synchronization control signals SCTL1 and SCTL2 to the organic light emitting display device 520 and the shutter glasses 540, respectively. Thus, the shutter glasses 540 may open the left shutter (i.e., close the right shutter) when the organic light emitting display device 520 displays the left image frame. Similarly, the stereoscopic display synchronization device 560 may provide the first and second synchronization control signals SCTL1 and SCTL2 to the organic light emitting display device 520 and the shutter glasses 540, respectively. Thus, the shutter glasses 540 may open the right shutter (i.e., close the left shutter) when the organic light emitting display device 520 displays the right image frame. In an exemplary embodiment, the stereoscopic display synchronization device 560 may provide the first and second synchronization control signals SCTL1 and SCTL2 to the organic light emitting display device 520 and the shutter glasses 540, respectively by wire and/or wireless communication links. In an exemplary embodiment, as illustrated in FIG. 8, the stereoscopic display synchronization device 560 may be located outside the organic light emitting display device 520 and the shutter glasses 540. In another exemplary embodiment, the stereoscopic display synchronization device 560 may be located within the organic light emitting display device 520 or the shutter glasses 540. In summary, the stereoscopic image display system 500 may provide a viewer (i.e., a user) with a high-quality stereoscopic image by including the organic light emitting display device 520 employing the digital driving technique (e.g., a random scan digital driving technique), where the organic light emitting display device 520 sets a black data period to be shorter than a real data period, and sets one horizontal time period 1H of the black data period to be shorter than one horizontal time of the real data period when dividing one image frame (i.e., the left image frame and the right image frame) into the black data period and the real data period.

FIG. 10 is a block diagram illustrating an electronic device having the stereoscopic image display system of FIG. 8.

Referring to FIG. 10, the electronic device 1000 may include a processor 1010, a memory device 1020, a storage device 1030, an input/output (I/O) device 1040, a power supply 1050, and a stereoscopic image display system 1060. The stereoscopic image display system 1060 may correspond to the stereoscopic image display system 500 of FIG. 8. In addition, the electronic device 1000 may further include a plurality of ports for communicating a video card, a sound card, a memory card, a universal serial bus (USB) device, other electronic devices, etc.

The processor 1010 may perform various computing functions. The processor 1010 may be a micro-processor, a central processing unit (CPU), etc. The processor 1010 may be coupled to other components via an address bus, a control bus, a data bus, etc. Further, the processor 1010 may be coupled to an extended bus, such as a peripheral component interconnection (PCI) bus. The memory device 1020 may store data for operations of the electronic device 1000. For example, the memory device 1020 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device, such as a dynamic random access memory (DRAM) device, a static random access memory (SRAM) device, a mobile dynamic random access memory (mobile DRAM) device, etc. The storage device 1030 may be a solid state drive (SSD) device, a hard disk drive (HDD) device, a CD-ROM device, etc.

The I/O device 1040 may be an input device such as a keyboard, a keypad, a mouse, a touchpad, a touch-screen, a remote controller, etc., and an output device such as a printer, a speaker, etc. In an exemplary embodiment, the stereoscopic image display system 1060 may be included in the I/O device 1040. The power supply 1050 may provide a power for operations of the electronic device 1000. The stereoscopic image display system 1060 may communicate with other components via the buses or other communication links. As described above, the stereoscopic image display system 1060 may include an organic light emitting display device, shutter glasses, and a stereoscopic image synchronization device. Here, the organic light emitting display device may display a stereoscopic image using a digital driving technique. Specifically, the organic light emitting display device may receive a stereoscopic image frame, divide the stereoscopic image frame into a left image frame and a right image frame, and alternately display the left image frame and the right image frame based on a first synchronization control signal. The shutter glasses may alternately open a left shutter and a right shutter based on a second synchronization control signal. The stereoscopic image synchronization device may output the first synchronization control signal and the second synchronization control signal to the organic light emitting display device and the shutter glasses, respectively. As a result, the left shutter of the shutter glasses may be open (i.e., the right shutter of the shutter glasses may be closed) when the organic light emitting display device displays the left image frame, and the right shutter of the shutter glasses may be open (i.e., the left shutter of the shutter glasses may be closed) when the organic light emitting display device displays the right image frame.

The stereoscopic image may be displayed based on interactions of the organic light emitting display device, the shutter glasses, and the stereoscopic image synchronization device in the stereoscopic image display system 1060. Specifically, the organic light emitting display device may divide the left image frame into a left black data period and a left real data period, and may divide the right image frame into a right black data period and a right real data period. Here, the stereoscopic image display system 1060 may set the left real data period to be longer than the left black data period, and may set one horizontal time period 1H of the left black data period to be shorter than one horizontal time period 1H of the left real data period. In addition, the stereoscopic image display system 1060 may set the right real data period to be longer than the right black data period, and may set one horizontal time period 1H of the right black data period to be shorter than one horizontal time period 1H of the right real data period. Thus, the stereoscopic image display system 1060 may sufficiently secure the left real data period of the left image frame and the right real data period of the right image frame, where an image corresponding to real data is displayed in the left real data period and the right real data period. As a result, the stereoscopic image display system 1060 may provide a viewer (i.e., a user) with a high-quality stereoscopic image. As described above, a method of displaying a stereoscopic image, an organic light emitting display device, and a stereoscopic image display system according to exemplary embodiments are described with reference to FIGS. 1 through 10, but the present invention is not limited thereto. For example, the present inventive concept may be applied to any display device (e.g., a liquid crystal display device, etc.) that employs a digital driving technique, as well as an organic light emitting display device that employs the digital driving technique.

The present invention may be applied to an electronic device having a display device that employs a digital driving technique. For example, the present invention may be applied to a television, a computer monitor, a laptop, a digital camera, a cellular phone, a smart phone, a personal digital assistant (PDA), a portable multimedia player (PMP), an MP3 player, a navigation system, a video phone, etc.

A method of displaying a stereoscopic image for an organic light emitting display device according to the disclosed exemplary embodiments, where the organic light emitting display device selectively displays a planar image and a stereoscopic image using a digital driving technique (e.g., a random scan digital driving technique), may improve image quality of the stereoscopic image by setting a black data period to be shorter than a real data period, and by setting one horizontal time period of the black data period to be shorter than one horizontal time period of the real data period when one image frame (i.e., a left image frame and a right image frame) is divided into the black data period and the real data period to display the stereoscopic image.

In addition, an organic light emitting display device according to the disclosed exemplary embodiments may sufficiently secure a real data period of a left image frame and a real data period of a right image frame, where an image corresponding to real data are displayed in the real data period, by employing the method of displaying the stereoscopic image.

Furthermore, a stereoscopic image display system having the organic light emitting display device according to the disclosed exemplary embodiments may provide a high-quality image to a viewer.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of displaying a stereoscopic image for an organic light emitting display device that selectively displays a planar image and the stereoscopic image using a digital driving technique, the method comprising:
setting a display mode of the organic light emitting display device to be a stereoscopic image display mode for displaying the stereoscopic image;
dividing a left image frame into a left black data period, in which an image corresponding to black data is displayed, and a left real data period, in which an image corresponding to left real data is displayed;
dividing a right image frame into a right black data period, in which an image corresponding to the black data is displayed, and a right real data period, in which an image corresponding to right real data is displayed; and
synchronizing the left image frame and the right image frame with a left shutter and a right shutter of shutter glasses, respectively,
wherein the left real data period is set to be longer than the left black data period, and the right real data period is set to be longer than the right black data period.

2. The method of claim 1, wherein the digital driving technique comprises a random scan digital driving technique.

3. The method of claim 1, wherein one horizontal time period of the left black data period is set to be shorter than one horizontal time period of the left real data period, and one horizontal time period of the right black data period is set to be shorter than one horizontal time period of the right real data period.

4. The method of claim 3, wherein each of the left black data period and the right black data period corresponds to a time period in which one scan operation is completed on all scan-lines of the organic light emitting display device.

5. The method of claim 3, wherein each of the left black data period and the right black data period corresponds to a time period in which a plurality of scan operations are completed on all scan-lines of the organic light emitting display device.

6. The method of claim 1, wherein:
the left shutter of the shutter glasses is open and the right shutter of the shutter glasses is closed when the left image frame is displayed; and
the right shutter of the shutter glasses is open and the left shutter of the shutter glasses is closed when the right image frame is displayed.

7. The method of claim 6, wherein:
each of the left real data period and the right real data period includes a plurality of sub-frames; and
a gray level of the left real data and a gray level of the right real data are displayed based on a sum of respective emission time periods of the sub-frames.

8. The method of claim 7, wherein the respective emission time periods of the sub-frames differ from each other by a factor of 2.

9. An organic light emitting display device comprising:
a display configured to display a stereoscopic image using a digital driving technique, the display panel comprising pixel circuits;
a scan driving unit configured to provide a scan signal to the pixel circuits;
a data driving unit configured to provide a data signal to the pixel circuits;
a power unit configured to provide a high-power voltage and a low-power voltage to the pixel circuits;
a timing control unit configured to control the scan driving unit, the data driving unit, and the power unit based on a digital driving technique; and
a display mode control unit configured to control a display mode of the organic light emitting display device to selectively display a planar image and a stereoscopic image,
wherein, when the display panel displays a stereoscopic image, the timing control unit divides a left image frame into a left black data period and a left real data period, and the timing control unit divides a right image frame a right black data period and a right real data period, and
wherein the left real data period is set to be longer than the left black data period and the right real data period is set to be longer than the right black data period.

10. The device of claim 9, wherein the digital driving technique comprises a random scan digital driving technique.

11. The device of claim 9, wherein one horizontal time period of the left black data period is set to be shorter than one horizontal time period of the left real data period, and one horizontal time period of the right black data period is set to be shorter than one horizontal time period of the right real data period.

12. The device of claim 11, wherein each of the left black data period and the right black data period corresponds to a time period in which one scan operation is completed on all scan lines of the organic light emitting display device.

13. The device of claim 11, wherein each of the left black data period and the right black data period corresponds to a time period in which a plurality of scan operations are completed on all scan lines of the organic light emitting display device.

14. The device of claim 9, wherein:
the organic light emitting display device is synchronized with shutter glasses;
when the left image frame is displayed, a left shutter of the shutter glasses is open and a right shutter of the shutter glasses is closed, and
when the right image frame is displayed, the right shutter of the shutter glasses is open and the left shutter of the shutter glasses is closed.

15. A stereoscopic image display system comprising:
an organic light emitting display device configured to display a stereoscopic image using a digital driving technique by receiving a stereoscopic image frame, dividing the stereoscopic image into a left image frame and a right image frame, and alternately displaying the left image frame and the right image frame based on a synchronization control signal;
shutter glasses configured to alternately open a left shutter and a right shutter based on the synchronization control signal; and
a stereoscopic image synchronization device configured to output the synchronization control signal to control the shutter glasses to open the left shutter when the organic light emitting display device displays the left image frame, and to output the synchronization control signal to control the shutter glasses to open the right shutter when the organic light emitting display device displays the right image frame,
wherein the organic light emitting display device divides the left image frame into a left black data period and a left real data period, and divides the right image frame into a right black data period and a right real data period, and
wherein the organic light emitting display device sets the left real data period to be longer than the left black data period, and sets the right real data period to be longer than the right black data period.

16. The system of claim 15, wherein the stereoscopic image synchronization device is disposed in the organic light emitting display device or the shutter glasses.

17. The system of claim 16, wherein the organic light emitting display device comprises:
a display panel comprising pixel circuits;
a scan driving unit configured to provide a scan signal to the pixel circuits;
a data driving unit configured to provide a data signal to the pixel circuits;
a power unit configured to provide a high-power voltage and a low-power voltage to the pixel circuits;
a timing control unit configured to control the scan driving unit, the data driving unit, and the power unit based on the digital driving technique; and
a display mode control unit configured to control a display mode of the organic light emitting display device to selectively display a planar image and the stereoscopic image.

18. The system of claim 17, wherein one horizontal time period of the left black data period is set to be shorter than one horizontal time period of the left real data period, and one horizontal time period of the right black data period is set to be shorter than one horizontal time period of the right real data period.

19. The system of claim 18, wherein each of the left black data period and the right black data period corresponds to a time period in which one scan operation is completed on all scan lines of the organic light emitting display device.

20. The system of claim 18, wherein each of the left black data period and the right black data period corresponds to a time period in which a plurality of scan operations are completed on all scan lines of the organic light emitting display device.
